(19) United States
(12) Patent Application Publication
(10) Pub. No.: US 2016/0253542 A1
(43) Pub. Date: Sep. 1, 2016

(54) BIOMETRIC RECOGNITION APPARATUS WITH CURVED SUBSTRATE

(71) Applicant: SUPERC-TOUCH CORPORATION, New Taipei City (TW)

(72) Inventors: Hsiang-Yu LEE, New Taipei City (TW); Shang CHIN, New Taipei City (TW); Ping-Tsun Lin, New Taipei City (TW)

(21) Appl. No.: 15/043,823

(22) Filed: Feb. 15, 2016

(30) Foreign Application Priority Data
Feb. 26, 2015 (TW) 104106187

(51) Int. Cl. G06K 9/00

(52) U.S. Cl. CPC G06K 9/0002

(57) ABSTRACT

A biometric recognition apparatus includes a curved substrate, a sensing electrode layer, and a plurality of selection switches. The sensing electrode layer is arranged on one side of the curved substrate. The sensing electrode layer has a plurality of sensing electrodes. The selection switches sequentially or dynamically select at least one sensing electrode to be one or more than one sensing electrode assemblies.

### BACKGROUND OF THE INVENTION

1. Field of the Invention

The present invention relates to a biometric recognition apparatus with curved substrate, especially to biometric recognition apparatus having curved substrate and sensing fingerprint characteristics.

2. Description of Prior Art

Biometric recognition technology has been widely applied to personal identification and authentication. The conventional biometric recognition technologies can be classified into fingerprint recognition, voice recognition, iris recognition or retina recognition and so on. Due to safety and efficiency considerations, fingerprint recognition becomes main stream technology. For recognizing fingerprint, user's fingerprint is first scanned and the unique features related to the scanned fingerprint are stored. The unique features are compared with the registered information in database for personal identification and authentication.

The fingerprint recognition device can scan fingerprint image by optical scanning, thermal imaging or capacitive imaging. The optical scanning scheme is bulky and hard to be used for portable electronic device. The thermal imaging has poor preciseness and robustness. Therefore, capacitive fingerprint sensor becomes popular for biometric recognition technology applied to portable electronic devices. Moreover, biometric recognition technologies have rapid development as the strong request from electronic security applications and automatic access control system. The biometric recognition technologies can be classified into fingerprint recognition, iris recognition or DNA recognition and so on. For the considerations of efficiency, safety and non-invasiveness, the fingerprint recognition becomes main stream technology. The fingerprint recognition device can scan fingerprint image by optical scanning, thermal imaging or capacitive imaging. For cost, power-saving, reliability and security concerns, the capacitive fingerprint sensor becomes popular for biometric recognition technology applied to portable electronic devices.

The conventional capacitive fingerprint sensors can be classified into swipe type and area type (pressing type), and the area type has better identification correctness, efficiency and convenience. However, the area type capacitive fingerprint sensor generally integrates the sensing electrodes and the sensing circuit into one integrated circuit (IC) protected by a sapphire film with thickness below 100 um because the sensed signals are minute and the background noise is huge in comparison with the minute sensed signals. As a result, the material cost and package cost is high and the product lifetime and durability are influenced. It is a development trend to enhance the sensing ability and signal-to-noise ratio for the sensing circuit such that the sensing electrodes can be placed on the substrate other than that for integrated circuit (IC). Therefore, the sensing area can be increased while the cost can be decreased. Moreover, the lifetime and durability are enhanced.

FIG. 1 shows an exploded view of a prior art fingerprint sensor (US 2013/0181949), which is filed by Apple Inc., and is related to a planar-type fingerprint sensor. The user finger 10A swipes on the fingerprint sensor 20A with planar sensing area, and the fingerprint sensing IC therein can sense images or features related to the user finger. However, due to the flatness of the sensing area, user needs to exert certain force on his finger to make his finger skin become flat to fit the planar sensing area. The fingerprint pattern is distorted, namely, the fingerprint touch area increases and the distance between adjacent valleys becomes smaller. The scanned data varies each time with different distorted fingerprint caused by different exerting force. As a result, the scanned fingerprint image is incorrect and the recognition may be erroneous.

### SUMMARY OF THE INVENTION

It is an object of the present invention to provide a biometric recognition apparatus with a curved substrate, which can fit with the roundness of user finger such that the pressed finger is not distorted to increase effective sensing area and enhance recognition correctness.

Accordingly, the present invention provides a biometric recognition apparatus, comprising: a curved substrate; a sensing electrode layer arranged on one side of the curved substrate and comprising a plurality of sensing electrodes; a plurality of selection switches operatively connected with the sensing electrodes and sequentially or dynamically selecting at least one sensing electrode to be one or more than one sensing electrode assemblies.

According to one embodiment of the present invention, the curved substrate is arc-shaped substrate or spherical substrate.

According to one embodiment of the present invention, the curved substrate is polymer thin-film substrate, super-thin glass substrate or metallic substrate.

According to one embodiment of the present invention, the polymer thin-film is polyimide (PI) thin film.

According to one embodiment of the present invention, the metal is stainless steel, aluminum (Al), copper (Cu), titanium (Ti), tungsten (W), silver (Ag), tin (Sn), iron (Fe) or the alloy of above metals, or liquid alloy.

According to one embodiment of the present invention, the biometric recognition apparatus comprises a wiring layer arranged on one side of the sensing electrode layer opposite to the curved substrate; the wiring layer has a plurality of wirings and each of the wirings being electrically coupled to at least one sensing electrode.

According to one embodiment of the present invention, the biometric recognition apparatus comprises a wiring layer arranged on one side of the sensing electrode layer toward the curved substrate; the wiring layer has a plurality of wirings and each of the wirings being electrically coupled to at least one sensing electrode.

According to one embodiment of the present invention, the biometric recognition apparatus comprises an insulating layer arranged between the sensing electrode layer and the wiring layer.

According to one embodiment of the present invention, the biometric recognition apparatus comprises an insulating layer arranged between the sensing electrode layer and the wiring layer.

According to one embodiment of the present invention, each of the selection switches is a thin film transistor circuit (TFT) switch or field effect transistor circuit (FET) switch.

According to one embodiment of the present invention, the selection switches are arranged on the curved substrate.

According to one embodiment of the present invention, the biometric recognition apparatus comprises a protection layer arranged on one side of the sensing electrode layer opposite to the curved substrate.

According to one embodiment of the present invention, the biometric recognition apparatus comprises a positioning part to guide user finger to a sensing position.

According to one embodiment of the present invention, the positioning part is a positioning bend or a positioning block.

According to one embodiment of the present invention, the biometric recognition apparatus comprises a self-capacitance measurement circuit.

According to one embodiment of the present invention, the self-capacitance measurement circuit is arranged in an integrated circuit (IC).

According to one embodiment of the present invention, the IC is bonded or press-welded to the curved substrate.

According to one embodiment of the present invention, the IC is bonded or press-welded to a flexible circuit board and one end of the flexible circuit board is connected to the curved substrate.

### BRIEF DESCRIPTION OF DRAWING

One or more embodiments of the present disclosure are illustrated by way of example and not limitation in the figures of the accompanying drawings, in which like references indicate similar elements. These drawings are not necessarily drawn to scale.

FIG. 1 shows an exploded view of a prior art fingerprint sensor.

FIG. 2A shows the perspective view of the curved substrate according to the first embodiment of the present invention.

FIG. 2B is a sectional view showing the application of the biometric recognition apparatus with curved substrate according to the first embodiment of the present invention.

FIG. 3A shows the perspective view of the curved substrate according to the second embodiment of the present invention.

FIG. 3B is a sectional view showing the application of the biometric recognition apparatus with curved substrate according to the second embodiment of the present invention.

FIGS. 3C and 3D respectively are sectional view showing the different embodiments of the positioning part.

FIG. 4A is a perspective view showing the application of the biometric recognition apparatus with curved substrate according to the third embodiment of the present invention.

FIG. 4B is the sectional view for FIG. 4A.

FIGS. 5A to 5C respective show the front view for the layered structure of the biometric recognition apparatus according to three different embodiments of the present invention.

FIG. 6 is an exploded view showing the layered structure of the biometric recognition apparatus with the curved substrate.

FIG. 7 is a partially enlarged view of the layered structure of the biometric recognition apparatus 100.

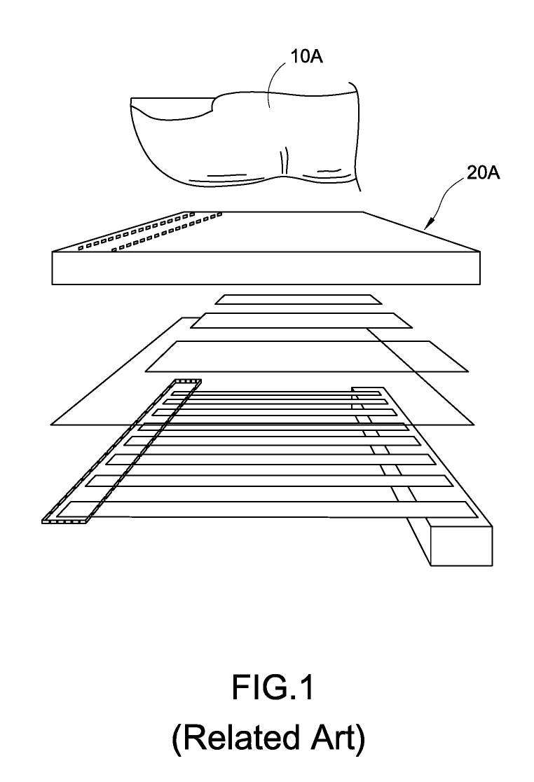

### DETAILED DESCRIPTION OF THE INVENTION

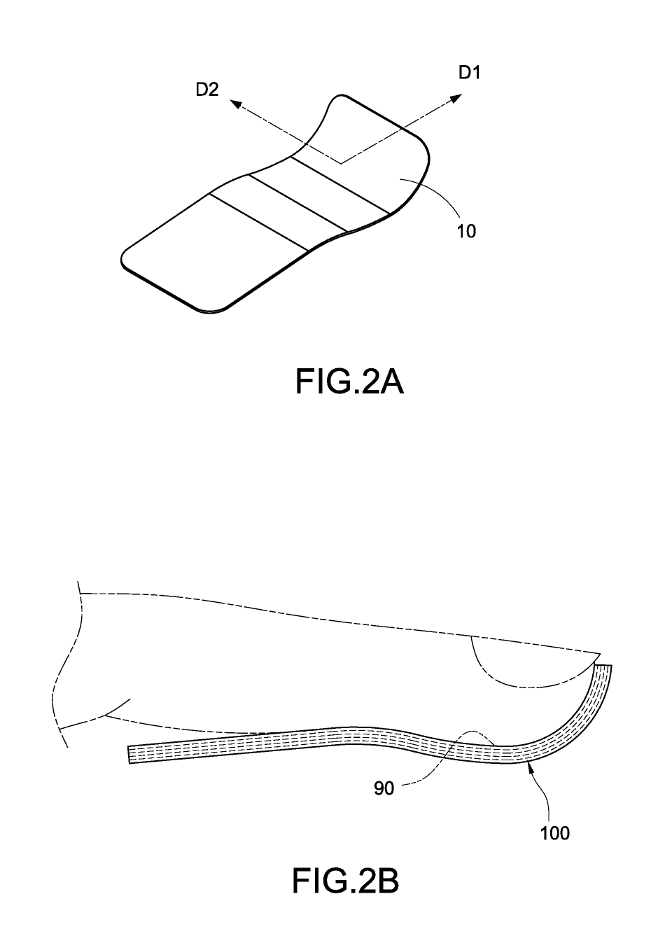

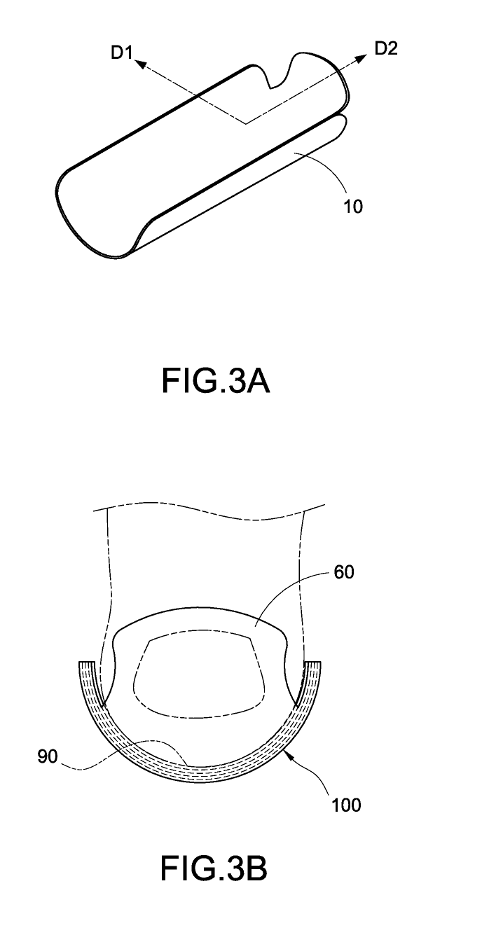

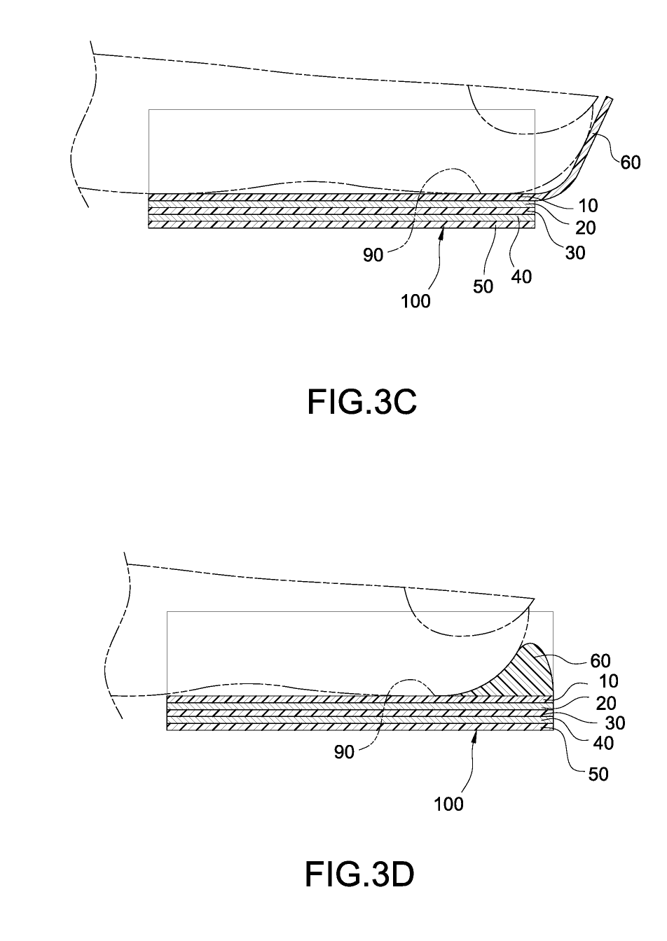

FIG. 2A shows the perspective view of the curved substrate according to the first embodiment of the present invention, and FIG. 3A shows the perspective view of the curved substrate according to the second embodiment of the present invention. In the embodiments shown in FIGS. 2A and 3A, the curved substrate 10 is curved substrate or flexible substrate. The direction D1 shown in FIGS. 2A and 3A is defined as the first direction (radial direction) for the curved substrate 10, and the direction D2 shown in FIGS. 2A and 3A is defined as the second direction (axial direction) for the curved substrate 10. A part of the curved substrate 10 has predetermined radius of curvature, and the predetermined radius of curvature can be, for example, larger than 0.5 cm to achieve the desired curvature for the curved substrate 10.

FIG. 2B is a sectional view showing the application of the biometric recognition apparatus 100 with curved substrate according to the first embodiment of the present invention, and FIG. 3B is a sectional view showing the application of the biometric recognition apparatus 100 with curved substrate according to the second embodiment of the present invention. User can perform personal identification and authentication by pressing his/her finger against the biometric recognition apparatus 100. In the embodiment shown in FIG. 2B, the first direction D1 is the direction along which user′ finger extends. In the embodiment shown in FIG. 3B, the second direction D2 is the direction along which user′ finger extends.

In the embodiment shown in FIG. 2B, the curvature of the curved substrate 10 can be such designed to fit with the curvature of user's finger. Therefore, user's finger skin has substantially full contact with the curved substrate 10. Moreover, the user's finger extends along the radial direction D1 in recognition operation such that the user's finger is blocked by a curved portion of the curved substrate 10. In other word, the user's finger can be firmly positioned on the biometric recognition apparatus 100 for precise personal identification and authentication.

In the embodiment shown in FIG. 3B, the curvature of the curved substrate 10 can be adapted to fit the circumference of user's finger such that the user's finger skin has substantially full contact with the curved substrate 10. As the finger extension direction is the second direction (axial direction) D2 in FIG. 3B, the biometric recognition apparatus 100 further comprises a positioning part 60 for facilitating finger pressing operation. FIGS. 3C and 3D respectively are sectional view showing the different embodiments of the positioning part 60. In the embodiment shown in FIG. 3C, the positioning part 60 is a positioning bend. The user can be aware of the right pressing position as his finger moves along the axial direction D2 and is blocked by the positioning bend 60. In the embodiment shown in FIG. 3D, the positioning part 60 is a positioning block. The user can be aware of the right pressing position as his finger moves along the axial direction D2 and is blocked by the positioning block 60. By the provision of the positioning part 60, user can more precisely press his finger on the right sensing area. Moreover, the positioning part 60 can be in one-piece form with the curved substrate 10, or integral with the curved substrate 10. The structure of the biometric recognition apparatus 100 will be detailed in following description.

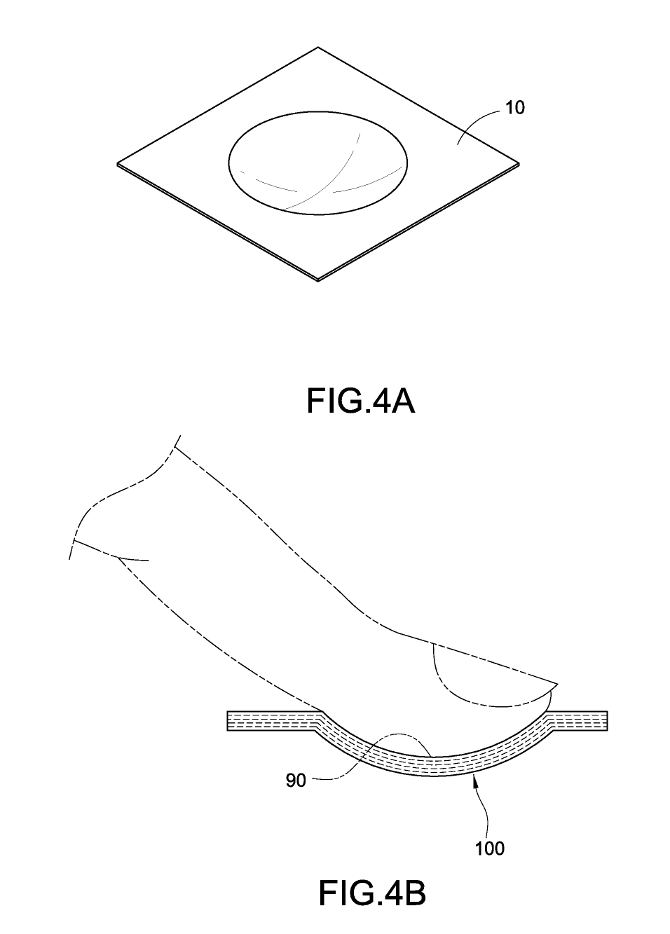

FIG. 4A is a perspective view showing the application of the biometric recognition apparatus 100 with curved substrate according to the third embodiment of the present invention, and FIG. 4B is the sectional view for FIG. 4A. The curved substrate 10 can be processed to form a substrate with rounded portion. More particularly, the rounded portion can be a spherical portion or an elliptical portion. By the rounded portion (such as rounded dent) provided on the curved substrate 10, user can be aware of the right pressing position and the sensing result for fingerprint can be more precise due to a full contact between user finger skin and the curved operation surface of the biometric recognition apparatus 100.

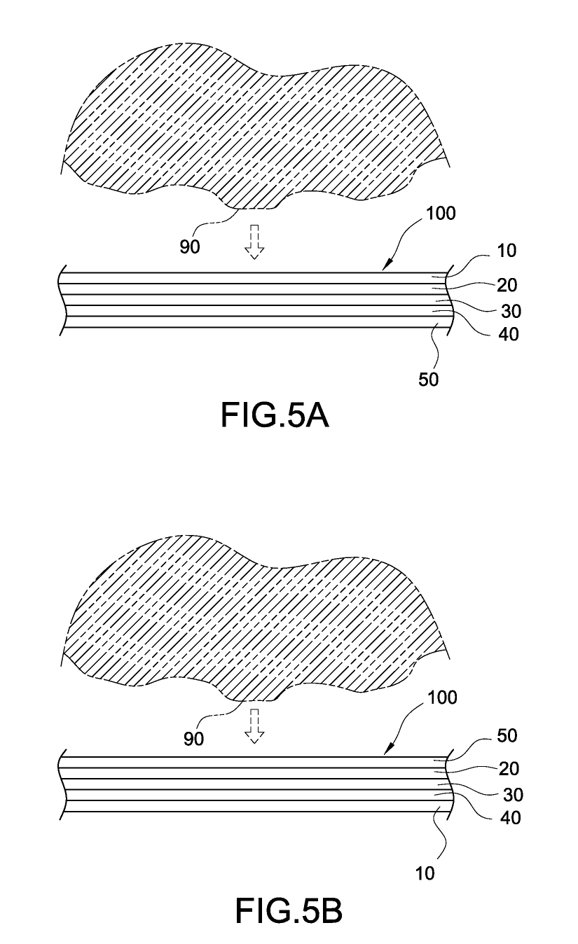

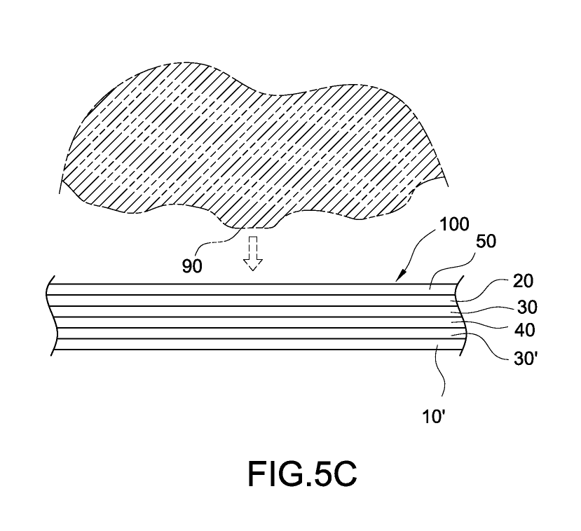

FIGS. 5A to 5C respective show the front view for the layered structure of the biometric recognition apparatus 100 according to three different embodiments of the present invention. The front view is viewed from a direction along an extension direction (axial direction) of user finger. The biometric recognition apparatus 100 shown in FIG. 5A comprises, from top (closest to user finger) to bottom direction, a curved substrate 10, a sensing electrode layer 20, an insulating layer 30, a wiring layer 40 and a protection layer 50. In this embodiment, the curved substrate 10 is, for example, made from polymer thin film or super-thin glass substrate. The polymer thin film can be polyimide (PI) thin film. The super-thin glass substrate has a thickness below 200 μm. The insulating layer 30 provides electric isolation between the sensing electrode layer 20 and the wiring layer 40. The protection layer 50 protects the biometric recognition apparatus 100 from oxidation and moisture.

The biometric recognition apparatus 100 shown in FIG. 5B comprises, from top (closest to user finger) to bottom direction, the protection layer 50, the sensing electrode layer 20, the insulating layer 30, the wiring layer 40 and the curved substrate 10. In comparison with the embodiment shown in FIG. 5A, the embodiment shown in FIG. 5B exchanges the positions of the protection layer 50 and the curved substrate 10. Nevertheless, the sensing electrode layer 20 is still ranked as second layer counted from the top direction. The ridges and valleys on the fingerprint 90 have only tiny separation and are difficult to sense. Therefore, the sensing electrode layer 20 is preferably ranked as second layer counted from the top direction in the layered structure such that the sensing electrode layer 20 can be close to user finger. It should be noted the biometric recognition apparatus 100 can adopt the self-capacitance sensing circuit disclosed in U.S. Pat. No. 8,704,539 filed by the same inventor and incorporated wholly here for reference. By the self-capacitance sensing circuit, the fingerprint can be precisely sensed even though the separation between the sensing electrode layer 20 and the user finger skin is more than 100 μm.

The biometric recognition apparatus 100 shown in FIG. 5C comprises, from top (closest to user finger) to bottom direction, the protection layer 50, the sensing electrode layer 20, the insulating layer 30, the wiring layer 40, a second insulating layer 30′ and a curved substrate 10′. In this embodiment, the curved substrate 10′ is a metallic curved substrate 10′. Furthermore, the metal can be stainless steel, aluminum (Al), copper (Cu), titanium (Ti), tungsten (W), silver (Ag), tin (Sn), iron (Fe) or the alloy of above metals, or liquid alloy. Moreover, another insulating layer 30′ is provided between the wiring layer 40 and the curved substrate 10′ to provide electric isolation therebetween. The metallic curved substrate 10′ can also provide shielding effect against high-frequency electromagnetic field.

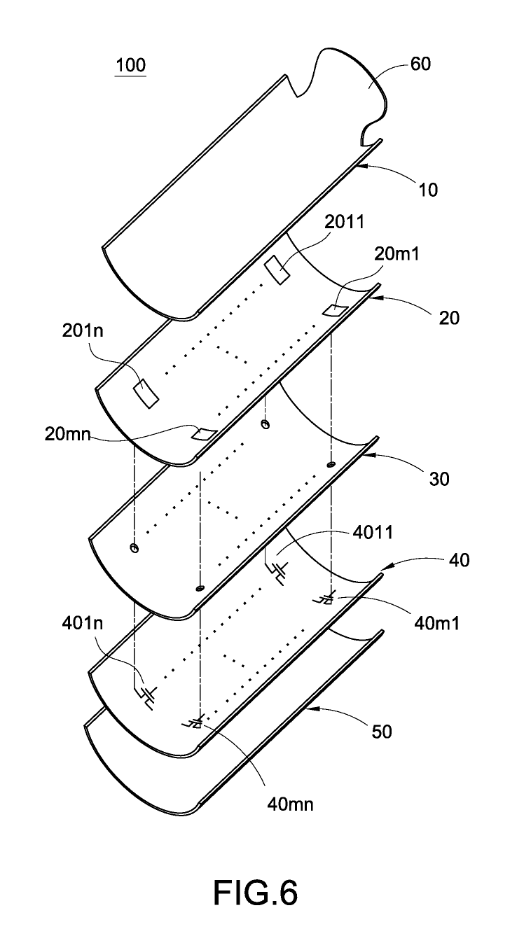

FIG. 6 is an exploded view showing the layered structure of the biometric recognition apparatus 100 with the curved substrate 10, which is corresponding to the embodiment shown in FIG. 5A. Namely, the biometric recognition apparatus 100 comprises, from top (closest to user finger) to bottom direction, the curved substrate 10, the sensing electrode layer 20, the insulating layer 30, the wiring layer 40 and the protection layer 50. In this embodiment, the sensing electrodes 2011˜20mn are arranged on the sensing electrode layer 20 and each of the sensing electrodes 2011˜20mn is exemplified as rectangular shape. However, the shapes of the sensing electrodes 2011˜20mn can be changed according to practical need and can be, for example but not limited to, circular, square, rhomb, triangular or polygonal shape.

In the example shown in FIG. 6, the wiring layer 40 has a plurality of selection switches 4011˜40mn, and each of the selection switches 4011˜40mn can be thin film transistor (TFT) switch or field effect transistor (FET) switch. In FIG. 6, each of the selection switches 4011˜40mn is electrically connected to a corresponding one of the sensing electrodes 2011˜20mn through wiring (trace). For example, the selection switch 4011 is electrically connected to the corresponding sensing electrode 2011 through wiring; the selection switch 40mn is electrically connected to the corresponding sensing electrode 20mn through wiring, and so on. Moreover, the above wirings (traces) pass through holes on the insulating layer 30 to provide electric connection between the corresponding selection switches 4011˜40mn and the sensing electrodes 2011˜20mn. Moreover, this example is not limitation for the scope of the present invention. In other embodiment, one of the selection switches 4011˜40mn can be electrically connected to a plurality ones of the sensing electrodes 2011˜20mn through wiring (trace). Therefore, the selection switches 4011˜40mn can simplify the layout and design of wiring to further suppress electromagnetic interference. In other embodiments, the selection switches 4011˜40mn can be arranged on the curved substrate 10 and electrically coupled to the sensing electrodes 2011˜20mn on the sensing electrode layer 20 by wirings.

In an embodiment of the present invention, the selection switches 4011˜40mn sequentially or dynamically select at least one sensing electrode 2011˜20mn to be one or more than one sensing electrode assemblies for fingerprint measurement. The detailed operation of the selection switches 4011˜40mn can be referred to TW patent application 103128567, Taiwan Utility Model M491216 and M493114, which are also incorporated here for reference.

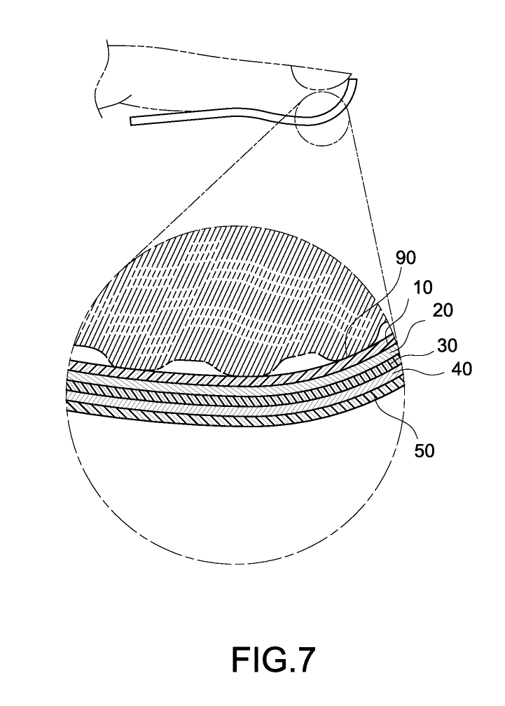

FIG. 7 is a partially enlarged view of the layered structure of the biometric recognition apparatus 100. As can be seen from FIG. 7, the fingerprint 90 with rounded surface can be in full contact (without distortion) with the curved substrate 10 when user finger is pressed on the biometric recognition apparatus 100 with the curved substrate 10. The capacitance sensing circuit, such as a self-capacitance sensing circuit, can precisely sense the different capacitances caused by the ridges and valleys of user finger.

The curved substrate 10 used in the biometric recognition apparatus 100 of the present invention can be manufactured by following manners. According to one embodiment of the present invention, the sensing electrodes, the TFT switches and wirings are first fabricated in a flexible planar substrate and the flexible planar substrate is then shaped or molded to become concave arc-shaped substrate or concave spherical substrate. The molding treatment includes thermal curing, radiation curing, and ultraviolet curing and so on. Alternatively, the substrate can have multi-layer structure (at least two layers) and the substrate is curved by etching or bending. Alternatively, the sensing electrodes, the TFT switches and wirings are first fabricated in a flexible planar substrate and the flexible planar substrate is then bonded to a frame or a casing with predetermined curvature.

Moreover, the biometric recognition apparatus 100 further comprises a self-capacitance sensing circuit, which can be referred to U.S. Pat. No. 8,704,539 filed by the same inventor. The self-capacitance sensing circuit is packaged in an IC and the IC can be directly bonded to or press-welded to the curved substrate 10. Alternatively, the IC with the self-capacitance sensing circuit is first bonded to or press-welded to a flexible printed circuit board and one end of the flexible printed circuit board is connected to the curved substrate 10.

To sum up, the biometric recognition apparatus with curved substrate has following advantages:

1. The biometric recognition apparatus 100 can be implemented by layered structure directly arranged on thin film substrate and no further packaging process is involved, thus reducing cost and simplifying process.

2. Contrary to the conventional planar type fingerprint recognition apparatus, the biometric recognition apparatus 100 has a curved substrate to increase sensing area and reduce fingerprint distortion, thus collecting more correct sensing data and enhancing recognition correctness.

3. The biometric recognition apparatus of the present invention can be first formed by planar stacked layer and then molded to have curved surface, which provides axial and radial direction fingerprint recognition, thus enhancing user convenience.

4. The position part (such as positioning bend or positioning block) can provide positioning reference to user to precisely position user finger to desired location.

5. By the provision of the selection switches 4011˜40mn, the wirings can be simplified and the electromagnetic interference can be reduced.

Thus, particular embodiments have been described. Other embodiments are within the scope of the following claims. For example, the actions recited in the claims may be performed in a different order and still achieve desirable results.

What is claimed is:

1. A biometric recognition apparatus, comprising:
a curved substrate;
a sensing electrode layer arranged on one side of the curved substrate and comprising a plurality of sensing electrodes;
a plurality of selection switches operatively connected with the sensing electrodes and sequentially or dynamically selecting at least one sensing electrode to be one or more than one sensing electrode assemblies.

2. The biometric recognition apparatus in claim 1, wherein the curved substrate is arc-shaped substrate or spherical substrate.

3. The biometric recognition apparatus in claim 1, wherein the curved substrate is polymer thin-film substrate, super-thin glass substrate or metallic substrate.

4. The biometric recognition apparatus in claim 3, wherein the polymer thin-film is polyimide (PI) thin film.

5. The biometric recognition apparatus in claim 3, wherein the metal is stainless steel, aluminum (Al), copper (Cu), titanium (Ti), tungsten (W), silver (Ag), tin (Sn), iron (Fe) or the alloy of above metals, or liquid alloy.

6. The biometric recognition apparatus in claim 1, further comprising a wiring layer arranged on one side of the sensing electrode layer opposite to the curved substrate, the wiring layer has a plurality of wirings and each of the wirings being electrically coupled to at least one sensing electrode.

7. The biometric recognition apparatus in claim 1, further comprising a wiring layer arranged on one side of the sensing electrode layer toward the curved substrate, the wiring layer has a plurality of wirings and each of the wirings being electrically coupled to at least one sensing electrode.

8. The biometric recognition apparatus in claim 6, further comprising an insulating layer arranged between the sensing electrode layer and the wiring layer.

9. The biometric recognition apparatus in claim 7, further comprising an insulating layer arranged between the sensing electrode layer and the wiring layer.

10. The biometric recognition apparatus in claim 1, wherein each of the selection switches is thin film transistor circuit (TFT) switch or field effect transistor circuit (FET) switch.

11. The biometric recognition apparatus in claim 10, wherein the selection switches are arranged on the curved substrate.

12. The biometric recognition apparatus in claim 1, further comprising a protection layer arranged on one side of the sensing electrode layer opposite to the curved substrate.

13. The biometric recognition apparatus in claim 1, further comprising a positioning part to guide user finger to a sensing position.

14. The biometric recognition apparatus in claim 13, wherein the positioning part is a positioning bend or a positioning block.

15. The biometric recognition apparatus in claim 1, further comprising a self-capacitance measurement circuit.

16. The biometric recognition apparatus in claim 15, wherein the self-capacitance measurement circuit is arranged in an integrated circuit (IC).

17. The biometric recognition apparatus in claim 16, wherein the IC is bonded or press-welded to the curved substrate.

18. The biometric recognition apparatus in claim 16, wherein the IC is bonded or press-welded to a flexible circuit board and one end of the flexible circuit board is connected to the curved substrate.
